(19) United States
(12) Patent Application Publication
(10) Pub. No.: US 2025/0205660 A1
(43) Pub. Date: Jun. 26, 2025

(54) Mixing Paddle with Replaceable Wear Resistant Element

(71) Applicant: Kennametal Inc., Latrobe, PA (US)

(72) Inventors: Ruy Frota de Souza Filho, Latrobe, PA (US); Pavel Ledyan, Bentonville, AR (US); Thomas Long, Greensburg, PA (US); Brandon Kenno, Windber, PA (US)

(73) Assignee: Kennametal Inc., Latrobe, PA (US)

(21) Appl. No.: 18/390,186

(22) Filed: Dec. 20, 2023

(51) Int. Cl. B01F 27/052; B01F 35/10

(52) U.S. Cl. CPC B01F 27/052; B01F 35/10

(57) ABSTRACT

An element or impeller includes a main body adapted to be operatively connected to a material processing machine, and a tip removably attached to the main body. The main body includes a first mounting element defining at least one of a protruding boss or a recess formed on a mounting end of the main body, and a through-hole extending through the main body. The through-hole is adapted to receive a fastening means therein. The tip includes a second mounting element defining at least one of a protruding boss or a recess complementary to the first mounting element. The second mounting element is formed on a mounting side of the tip, and is adapted to directly or indirectly engage with the first mounting element. The tip defines a bore extending therein. The bore and the through-hole are aligned (e.g., coaxially) when the tip is attached to the main body.

### FIELD OF THE INVENTION

The present disclosure relates to material processing devices, and more specifically, to a material processing element, such as an impeller, hammer, blade or paddle having at least one removeable element.

### BACKGROUND

Mixing, blending, comminution and classification operations, by way of example, are common in material processing and manufacturing across a wide variety of industries and applications. These processes may be performed by hand or by machine, and may utilize various modes of agitation to blend material (e.g., rotation, vibration, etc.) As an example, mixing machines often implement rotating or otherwise moving elements or impellers, such as paddles or blades, to merge materials together. Due to the often harsh mechanical properties of the material(s) being mixed, as well as operational parameters (e.g., mixing time, speed, etc.), wear on these elements may be substantial. As a result, the elements must be replaced with significant frequency. In addition to being costly, the routine replacement of these elements can be time consuming, and thus limiting to overall processing output and efficiency.

Additionally, wear on the elements may not be uniform, as frictional forces acting thereon tend to be highest on the leading edges and distal ends thereof. Thus, replacing an entire element may be unnecessarily wasteful. Likewise, the mechanical requirements for certain features or areas of the mixing element may be distinct from others. In this way, a monolithic element, as found in the prior art, may not be optimal. For example, for strength and corrosion resistance in a primary body and mounting area of the element (e.g., where the element is attached to a rotating spindle of a machine), a material such as stainless steel may be preferred. In distinction, it may be desired to form a tip, end and/or leading edge of the element from a harder and/or more wear resistant material, such as cemented tungsten carbide.

Accordingly, improved elements addressing the above drawbacks are desired.

### SUMMARY

According to an embodiment of the present disclosure, an element, such as an impeller or an impeller assembly, includes a main body adapted to be operatively connected to a material processing machine (e.g., a mixing machine), and a tip or end removably attached to the main body. The main body has a first mounting element defining at least one of a protruding boss or a recess formed on a mounting end thereof, and a through-hole or fastener opening extending through the main body. The through-hole is adapted to receive a fastening member or fastener for securing the tip to the main body. The tip includes a second mounting element defining at least one of a protruding boss or a recess complementary to the first mounting element. The second mounting element is formed on a mounting side or end of the tip, and is adapted to positively engage with the first mounting element (e.g., be inserted into or receive the first mounting element). The tip further defines a fastener bore extending therein. The fastener bore and the through-hole are coaxially aligned when the tip is attached to the main body, such that the fastening means may extend through the main body and into the tip for securing the tip to the main body.

### BRIEF DESCRIPTION OF THE DRAWINGS

The invention will now be described by way of example with reference to the accompanying Figures, of which:

FIG. 1 is a perspective view of an element, impeller, blade, or paddle according to an embodiment of the present disclosure;

FIG. 2 is a partial perspective view of the element of FIG. 1 illustrating a main body, a removeable and/or replaceable tip thereof, and a fastening means or fastener;

FIG. 3 is a partial perspective view of the main body and fastener of the element of the preceding figures with the tip removed therefrom;

FIG. 4 is a partial perspective view of the main body of the element of the preceding figures with the tip and fastener removed therefrom;

FIG. 5 is a partial perspective view of the main body of the element further illustrating the position of a fastener opening;

FIG. 6 is a side view of the tip of the element of the preceding figures;

FIG. 7 is a perspective view of the tip of the element of the preceding figures;

FIG. 8 is another perspective view of a tip of the element according to another embodiment of the present disclosure;

FIG. 9 is a partial perspective view of a mounting element of a tip according to another embodiment of the present disclosure;

FIG. 10 is a partial perspective view of a main body of an element according to another embodiment of the present disclosure;

FIG. 11 is a partial perspective view of an element according to another embodiment of the present disclosure;

FIG. 12 is a partial perspective view of an element according to another embodiment of the present disclosure;

FIG. 13 is a partial perspective view of an element according to another embodiment of the present disclosure;

FIG. 14 is a partial perspective view of an element according to another embodiment of the present disclosure;

FIG. 15 is a partial perspective view of an element according to another embodiment of the present disclosure;

FIG. 16 is a partial perspective view of an element according to another embodiment of the present disclosure;

FIG. 17 is a partial perspective view of a tip of the element of FIG. 16; and

FIG. 18 is a partial perspective view of an element according to another embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments of the present disclosure include a rotating element, impeller, paddle, or blade adapted to be mounted to a machine (e.g., to a rotating output thereof). The element includes a main body formed from a first material, such as stainless steel, and at least one replaceable end or tip removably attached thereto. The replaceable end may be formed from a second material, distinct from the first material, such as cemented tungsten carbide. The end defines at least a portion of a leading edge or working surface of the element adapted to be in contact with the material(s) during operation (e.g., mixing, dispersing, milling, etc.) In one exemplary embodiment, the end is secured to the main body via a fastening means or fastener. More specifically, the main body defines a fastener opening extending therethrough. The opening includes an open first end distal to the replaceable end and proximate a center of the main body, and an open second end formed through, or opening on, a mating face of the element. The fastener opening of the main body is aligned with a corresponding opening or bore formed in the replaceable end (e.g., a threaded opening formed into a boss of the replaceable end). The fastener is adapted to be inserted into the first end of the fastener opening of the main body, and engage with the opening in the replaceable end. Engagement (e.g., threading) of the fastener with the replaceable end is adapted to draw the end into abutting contact with the main body, selectively securing it thereto.

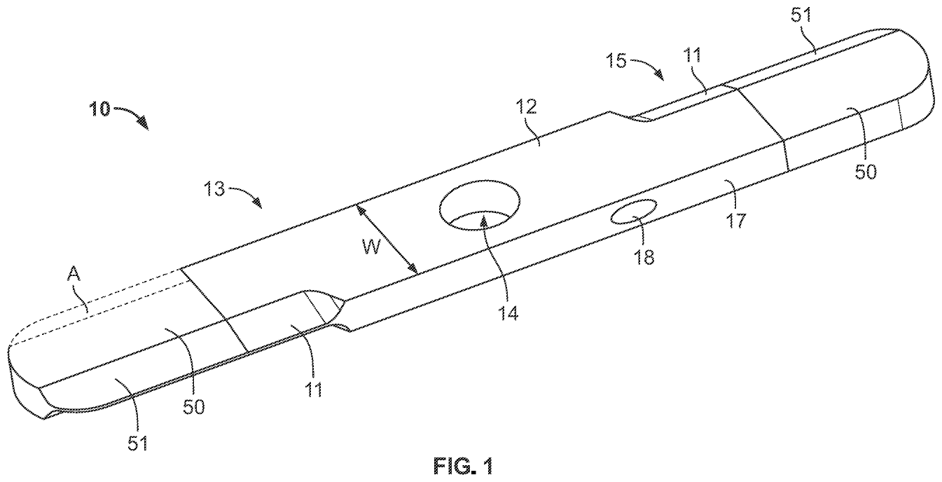

Referring generally to FIG. 1, a simplified exemplary element, impeller, paddle, or blade 10 is shown. The element 10 includes a main body 12 and a pair of removeable and/or replaceable ends or tips 50. The element 10 may be described as having two sides 13, 15 arranged opposite one another relative to a center of the element in a longitudinal direction. It should be understood that, but for their distinct orientation about a longitudinal axis, the longitudinal ends or sides 13, 15 of the element 10 may be identical to one another. Thus, the applicable descriptions herein will apply equally to either side 13, 15. While the exemplary embodiment includes two replaceable ends 50, it should be understood that the number of replaceable ends may be varied (e.g., 1, 3, etc.) without departing from the scope of the present disclosure. Further, while the exemplary ends 50 are each removeable, in other embodiments, one or more ends or tips may be irremovably fixed to the main body 12 (e.g., formed integrally therewith or bonded thereto).

The main body 12 defines a centrally located, generally circular opening 14 adapted to receive, for example, a drive spindle of a material processing machine. One or more keyways or splines may be defined within the opening 14 for engaging with corresponding drive keys or keyways of the spindle of the machine for driving the element 10 in a rotational manner. The main body 12 further includes tapered faces 11 defining portions of leading edges or working surfaces of the element 10. Likewise, the replaceable ends 50 may each include tapered faces 51 defining a remaining portion of a respective one of the leading edges of the element 10. Specifically, the tapered faces 51, 11 of each end 50 and the main body 12 define a continuous, uniform leading edge of the element 10 with the ends attached to the main body. In this way, the element 10 may be directional in nature (i.e., adapted to spin in a one direction during operation). As illustrated, the tapered faces 11 are formed only on each distal end of the exemplary main body 12. In other embodiments, the tapered faces 11 may extend over the entire length of each side 13, 15 of the element 10 (i.e., one-half of a total length of the element). In still other embodiments, no portion of the leading edges of the element 10 may be defined by the main body 12, rather, they may be defined only by the ends 50.

As shown in FIG. 1, the lateral sides of the element 10 opposite the leading edges in a width direction W may comprise trailing sides or edges 17 which may be oriented generally vertically between top and bottom surfaces of the main body 12 and/or the ends 50, and which may not define a taper. In other embodiments, the tapered leading edges of the element 10 may be formed on each lateral side thereof. In this embodiment, the element 10 may be used to act upon or process material in both rotational directions without the need to reorient the element relative to the machine.

Still referring to FIG. 1, in some embodiments, a width of the main body 12 and the ends 50 in the width direction W may be generally constant over the length of the element 10. In still other embodiments, the width of the element 10 may taper along its length in each outward radial direction from the center or opening 14. The same may be true for a thickness of the element 10 (i.e., it may be constant, tapered, or otherwise varying). Further, in the exemplary illustrated embodiment, each end 50 defines the entire tip or free end of the element 10 in the width direction W. In other embodiments, however, each end 50 may form only a portion of the distal end of the element 10 in the width direction W. For example, an area A of the free end of the element 10 may be formed integrally with the main body 12, with the removable end 50 defining the remaining portion of the free end. This embodiment may be mechanically advantageous in that forces acting generally normal to and upon the tapered face 51 of the end 50 are directly opposed by the main body 12, relieving stress or strain on the mounting elements by which the end is fixed to the main body.

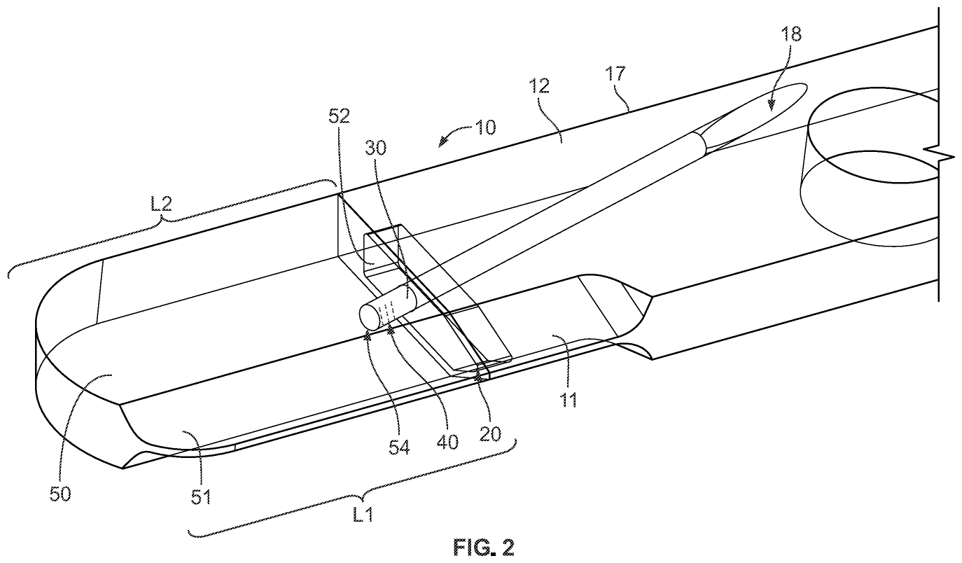

Referring now to FIG. 2, an exemplary mounting system or arrangement for attaching each end 50 to the main body 12 is shown. Specifically, the main body 12 of the element 10 defines a first mounting element in the form of a recess 20 defined into an end thereof. The recess 20 is formed into the main body 12 in an at least partially radially inward direction with respect to a center of the main body. A fastener bore or through-hole 18 is also define through the body 12, and is adapted (i.e., sized and shaped) to receive a fastening means or fastener 30 therein. The through-hole 18 extends from a lateral side of the main body 12, and specifically the trailing side 17 opposite the side defining the leading edge, to the recess 20.

The replaceable end 50 defines another or a second mounting element in the form of a protrusion or a boss 52. The boss 52 extends or protrudes from a mating end of the end 50 in an at least partially radially inward direction relative to the center of the main body 12 or the element 10. As will be set forth in detail herein, the boss 52 comprises a complementary shape to that of the recess 20, such that it is receivable within the recess in a sliding fit, transition fit, friction fit, interference fit, or press fit manner, by way of non-limiting example.

A bore 54 is formed into the boss 52 of the end 50 in an at least partially radially outward direction with respect to the center or opening 14 of the element 10. With the end 50 arranged on the main body 12, the bore 54 and the through-hole 18 are coaxially aligned such that the fastener 30 inserted through the through-hole is received within the end 50. More specifically, in the exemplary embodiment, the boss 52 and the fastener 30 may define a threaded connection 40, including an internal threading defined in the boss for engaging with an external threading of the fastener. It should be understood that the through-hole 18 and the fastener 30 may define a complementary shoulder and head, respectively, such that the depth of insertion of the fastener into the body 12 is limited. In this way, tightening or threading the fastener 30 into the bore 54 of boss 52 is operative to draw the end 50 at least partially radially inward toward the center of the element 10, securing at least a portion of the boss within the recess 20. As a threaded connection secures the end 50 to the main body 12, embodiments of the present disclosure provide a means to adjust the holding force securing the end to the main body. This is advantageous in that, depending on the differences in coefficients of thermal expansion between the ends 50 and the main body 12 of the element 10, any loosening of the ends relative to the main body may be addressed via periodic retorquing or tightening of the fastener 30.

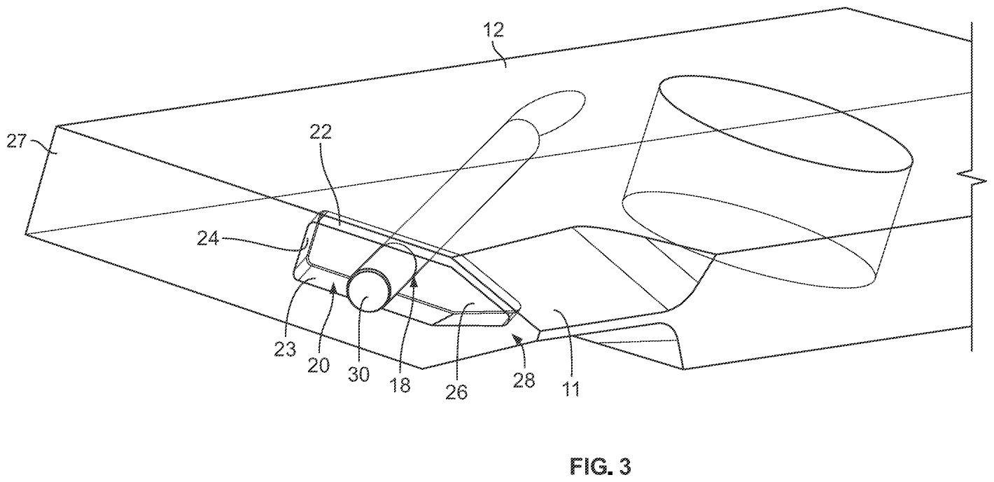

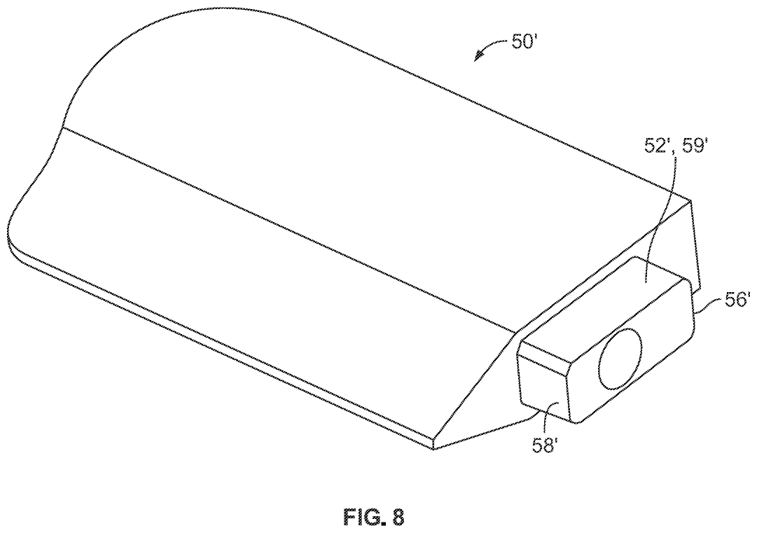

Still referring to FIG. 2, according to embodiments, a length of the lateral, leading edge side of the end 50 may have a length L1 that is equal to a length L2 of the opposite lateral side or trailing side 17. In other embodiments, the lengths of each lateral side L1, L2 may be distinct from one another. For example, the length L2 may be less than the length L1, in this way, the mating end surfaces or faces 27, 57 of the main body 12 and the end 50 (see FIGS. 3 and 7) may be defined on a plane oriented in a non-tangential manner with respect to the center of the element 10 and its rotational/circular path of operation. This may be mechanically advantageous, as the mating end surfaces 27, 57 of the main body 12 and end 50 at least partially oppose one another in a direction of the normal force acting on the leading edge of the element 10, thus improving support of the end relative to the main body under operational loading. Likewise, the reverse arrangement may be true without departing from the scope of the present disclosure.

The recess 20 of the main body 12 is shown in greater detail in FIG. 3. As illustrated, the recess 20 is defined into the mating end surface 27 by opposing top and bottom walls 22, 23, a first sidewall or rear wall 24, a base wall 26, and converging second sidewalls defining a tapered end 28. The tapered end 28 permits the recess 20 to extend into the leading edge defined by the converging tapered faces 11 of the main body 12. The end face or base surface 26 of the recess 20 is adapted to uniformly abut against an opposing end surface of the boss 52 in an installed position. In FIG. 3, the fastener 30 is shown in a full-inserted position, wherein it extends from a second end of bore 18 beyond an end of the main body 12 for engaging with, and extending through, the bore 54 of the boss 52.

In the exemplary embodiment, the top wall 22 and the bottom wall 23 taper in a converging manner in the radially inward direction of insertion of the boss 52 into the recess 20. With a taper angle of less than approximately 10 degrees, a press fit between the boss 52 of the end 50 and the recess 20 of the main body 12 may be achieved. In other embodiments, a taper may also be implemented on the corresponding surfaces of the boss 52, in lieu of the taper of top and bottom walls 22, 23, or in addition thereto, for achieving a similar fit.

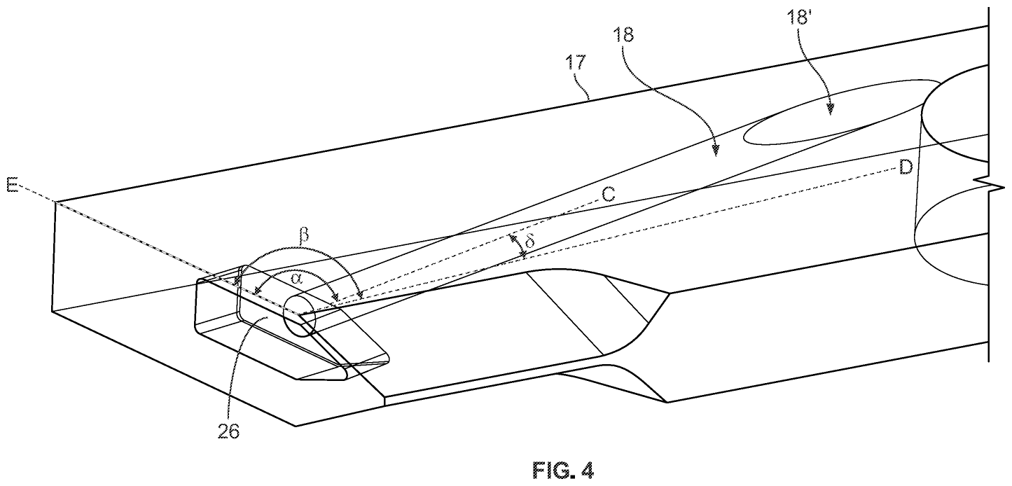

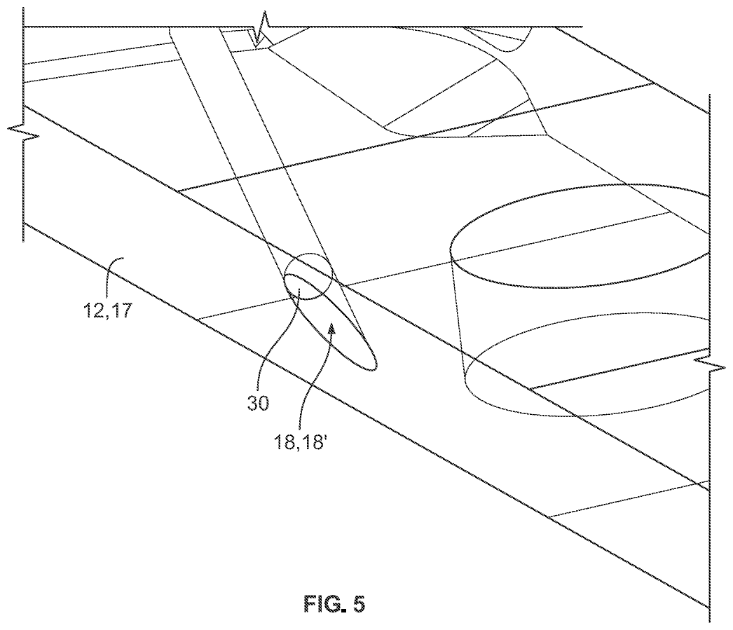

With reference now to FIGS. 4 and 5, a first end 18′ of the through-hole 18 is adapted to receive a tool for rotating or otherwise engaging the fastener 30 with the end 50. The first end 18′ of the through-hole 18 exits the second lateral or trailing side 17 of the main body 12 opposite the leading edge side. In this way, material(s) being processed by the element 10 is not forcibly introduced into the opening or through-hole 18 during operation, nor must the element 10 be removed from the machine in order to access the fastener 30 for removal of the end(s) 50. This improves reliability and cleanliness, and increases operational efficiency, as the ends 50 may be replaced with greater ease. In one embodiment, the lateral side exit of the through hole 18 is achieved by offsetting a central axis C of the through-hole 18 from a central axis of elongation D of the main body 12 by an exemplary non-zero angle δ (i.e., they are oriented obliquely or non-parallel with one another).

In order to advantageously apply a holding force on the end 50, the central axis C of the through-hole 18 (and thus of the fastener 30) may be oriented generally normally to a plane or axis E defined by the mating end surface 27 of the main body 12 (i.e., at an angle α of about ninety degrees). This ensures that even and/or uniform clamping or compressive force is generated between the abutting surfaces or faces of the end 50 and the main body 12. In other embodiments, the angle α may be less than ninety degrees. In this way, the force generated by the fastener 30 on the end 50 may be operative to draw a rear face or wall 56 of the boss 52 (see FIG. 7) into compressive or abutting contact with the rear wall 24 of the recess 20. This arrangement may provide additional support of the end 50 against forces acting on the leading edge of the element 10 during operation.

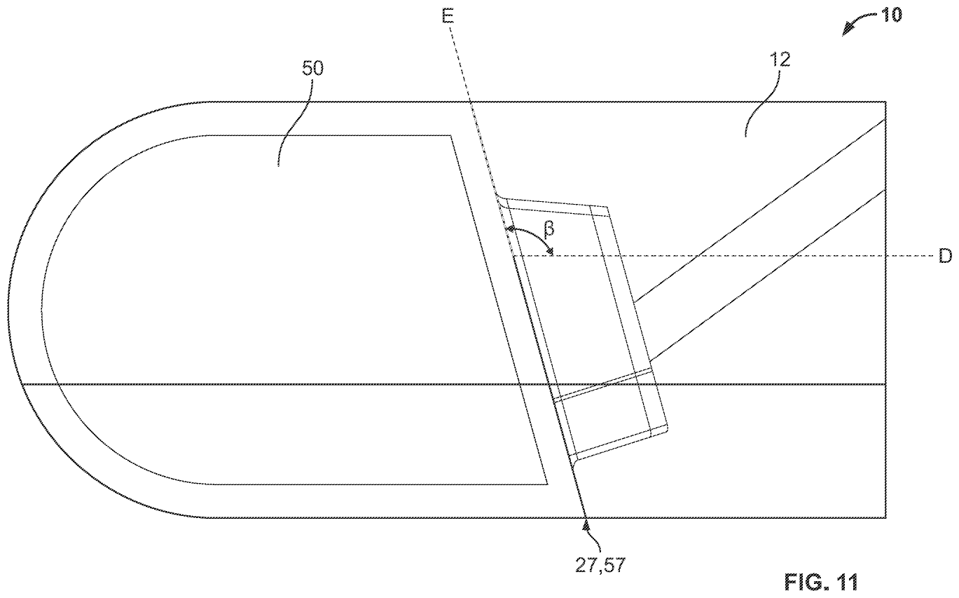

Similarly, an angle β between an end face of the main body 12 defined along the plane or axis E and the central axis of elongation D of the main body 12 may be approximately ninety degrees. In other embodiments, the angle β may be greater than ninety degrees, thus forming the angled mating surfaces 27, 57 of the main body 12 and the end 50 relative to a true tangential direction (i.e., the direction if the angle β is equal to ninety degrees) described above with respect to FIG. 2, and shown more clearly in FIG. 11. This arrangement increases the length of the tip or end 50 on the leading edge side which sees the most wear, as well as reduces the overall weight of the end. The resulting reduction in weight of the end 50 is advantageous in that, for example, it decreases stress on associated connecting elements. This is particularly beneficial as operational rotational speeds of the element 10 increase.

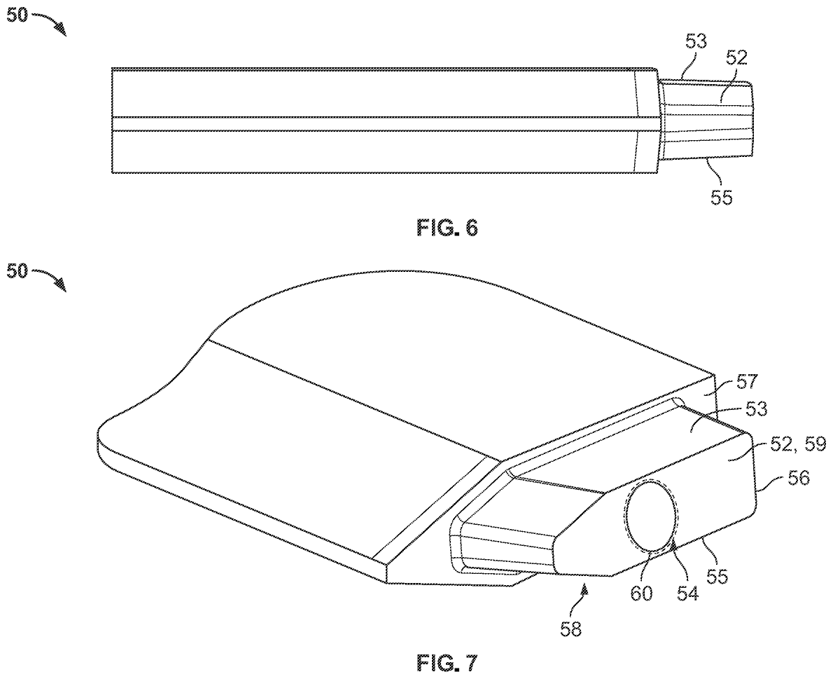

FIGS. 6 and 7 illustrate the replaceable and/or removeable end 50 according to a first embodiment of the present disclosure. As shown, the boss 52 of the end 50 may be formed integrally with a remainder of the end. Top and bottom walls 53, 55 of the boss 52 are shown, with each having a taper (e.g., less than ten degrees in total therebetween) for achieving a transition fit, interference fit, etc. with the recess 20 of the main body 12. The boss 52 further defines a generally vertical and/or linear rear face or wall 56 for opposing the rear wall 24 of the recess 20, and a pair of converging, tapering front or end walls defining a tapering end 58 complementary to the tapered end 28 of the recess 20, as shown in FIG. 3. Referring to FIG. 8, another embodiment of an end 50′ is shown. The end 50′ includes a boss 52′ having generally planar and parallel front and rear walls 56′, 58′, as distinct from the tapering walls of the embodiment of FIGS. 6 and 7.

Referring generally to FIGS. 3 and 7, in one embodiment, the boss 52 and the recess 20 are adapted to form an interference fit. More specifically, in one embodiment, the top and bottom walls 53, 55 of the boss 52 and/or the top and bottom walls 22, 23 of the recess 20 are tapered in an insertion direction of the end 50. These surfaces are adapted such that they engage or contact one another before the end faces 27, 57 of the main body 12 and end 50 are abutted together. In this way, as the end faces 27, 57 are drawn together, the surfaces of walls 22, 23, 53, 55, elastically deform, establishing the interference fit therebetween. It should be understood that this interference fit may be defined between any of at least two surfaces of the boss 52 and/or the recess 20. For example, in another embodiment, the tapered surfaces may be defined by the converging sidewalls of the recess 20 defining the tapered end 28 and/or the corresponding converging sidewalls of the boss 52 defining the tapered end 58.

Referring now to FIGS. 7 and 8, in any embodiment of the replaceable end 50, 50′, the boss 52, 52′ may be formed integrally with a remainder of the end. Likewise, the boss 52, 52′ may comprise the protruding end of a discrete insert 59, 59′ partially embedded within the end 50. More specifically, the end 50, 50′ may be formed of a first monolithic material such as carbide, while the insert 59, 59′ is formed from, for example, stainless steel. This insert 59, 59′ may be secured within the remainder of the end 50 via any suitable means, including bonding or brazing. In some embodiments, and particularly embodiments wherein the boss 52, 52′ is formed monolithically with the remainder of the end 50, a thread insert 60 (e.g., a helical insert or HELI-COIL®, see FIG. 7) may be provided within the opening 54 for forming and/or adding strength to the threaded connection between the end 50 and the fastener 30. In other embodiments, particularly those in which the boss 52, 52′ is a part of a metallic insert, a separate thread insert made not be necessary, as the inherent strength of the insert material may be sufficient to provide a strong, reliable connection with the fastener 30 (i.e., sufficient resistance to pull-out forces).

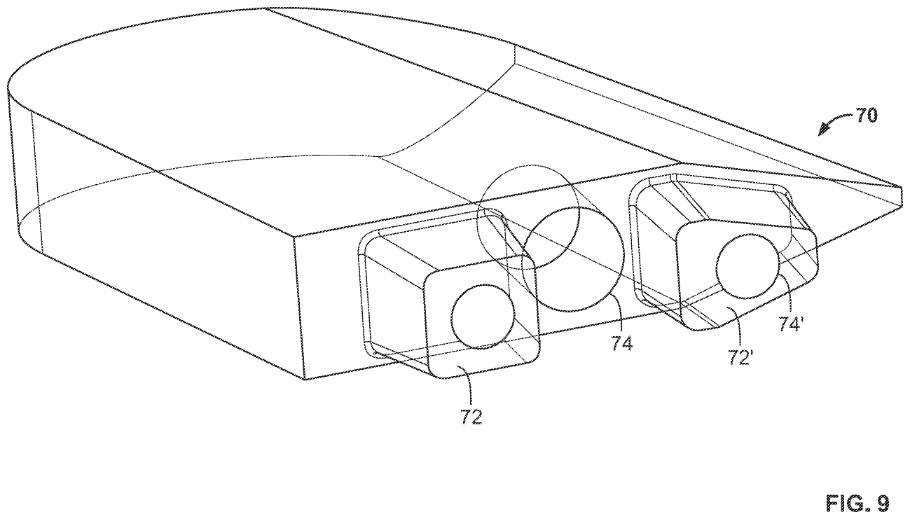

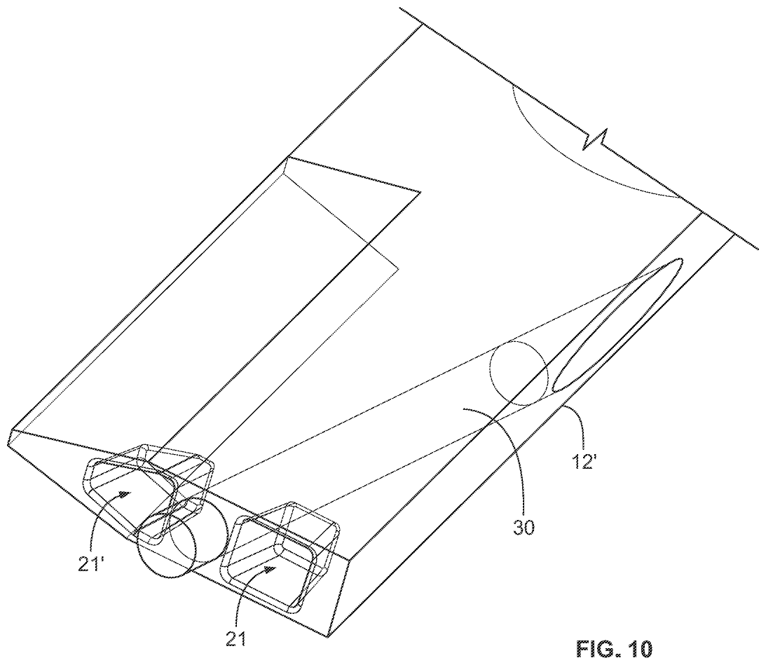

FIG. 9 shows another embodiment of a replaceable and/or removable end 70. The end 70 includes a protruding boss defined as two discrete protrusions 72, 72′ separated by a gap defined therebetween. As illustrated, one of the protrusions 72′ may comprise a tapered end face, similar to that described above with respect to the embodiment of FIGS. 1-7. A bore 74 (e.g., a threaded bore or a bore having a helical insert arranged therein) may be formed into the end 70 in a position between the protrusions 72, 72′, or a bore 74′ may be formed into one or more of the protrusions in which two fasteners 30 may be used to secure the end to the remainder of the element (e.g., element 10). It should be understood that in these embodiments, the recess formed into the end of the main body of the element may be the single recess 20 receiving both protrusions 72, 72′, as shown in the preceding figures, or two discrete and correspondingly shaped recesses 21, 21′ formed in a main body 12′ each receiving one of the protrusions, as shown in FIG. 10.

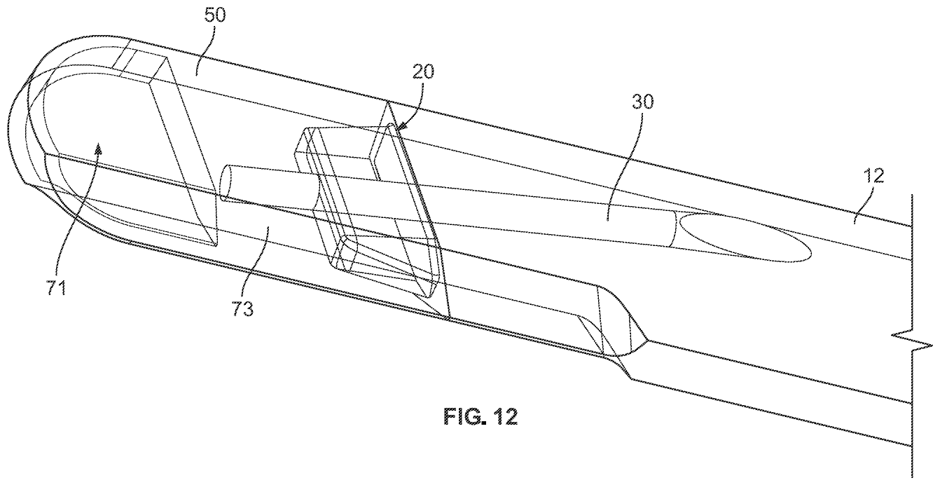

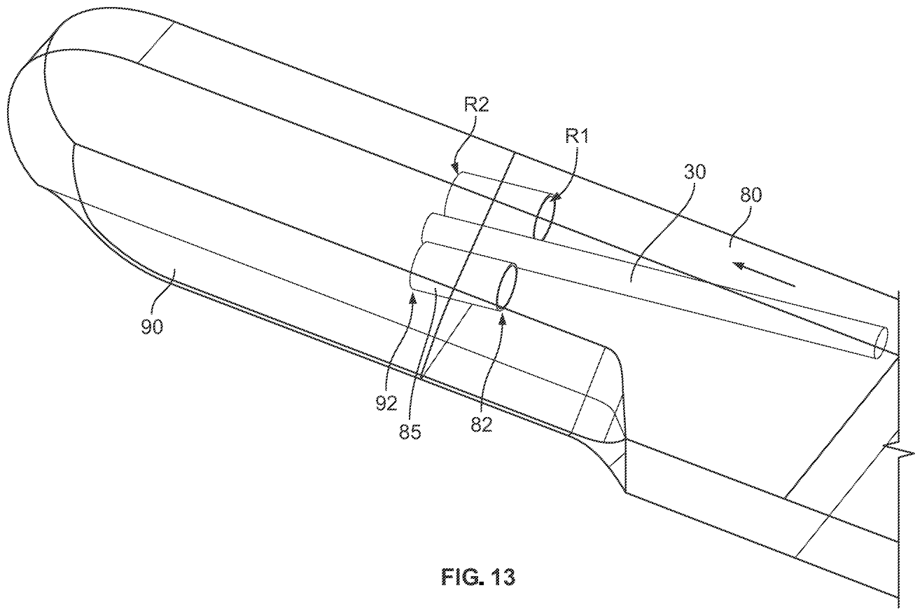

With reference to the exemplary embodiments of FIGS. 11 and 12, the wear resistant tip or end 50 according to each embodiment of the present disclosure may be generally hollow in order to reduce centripetal forces on, for example, the fastening assembly and/or interface between the tip and the main body of the element. By way of example, as shown in FIG. 12, this hollow interior may be defined by multiple distinct hollow spaces. More specifically, in the exemplary embodiment, the hollow interior is defined within the tip 50 by the recess 20 as generally described above, as well as a second hollow interior space 71 arranged primate a free end thereof. An intermediate area 73 between the recess 20 and the space 71 remains generally solid for enabling engagement with the fastener 30. It is also noted that the arrangement of the protruding boss and recess is reversed from those shown in the preceding embodiments (i.e., the body defines the boss, and the tip defines the recess).

In one embodiment, a total volume reduction resulting from this hollow form may range from about 10% to about 50% (i.e., the illustrated cavity inside the end occupies between about 10% to about 50% of an overall volume of the end). More preferably, the volume reduction range is about 20% to about 40%. These volume ranges and corresponding weight reductions have been determined to achieve suitable reductions in centripetal forces, while maintaining overall performance and durability requirements of the element or paddle.

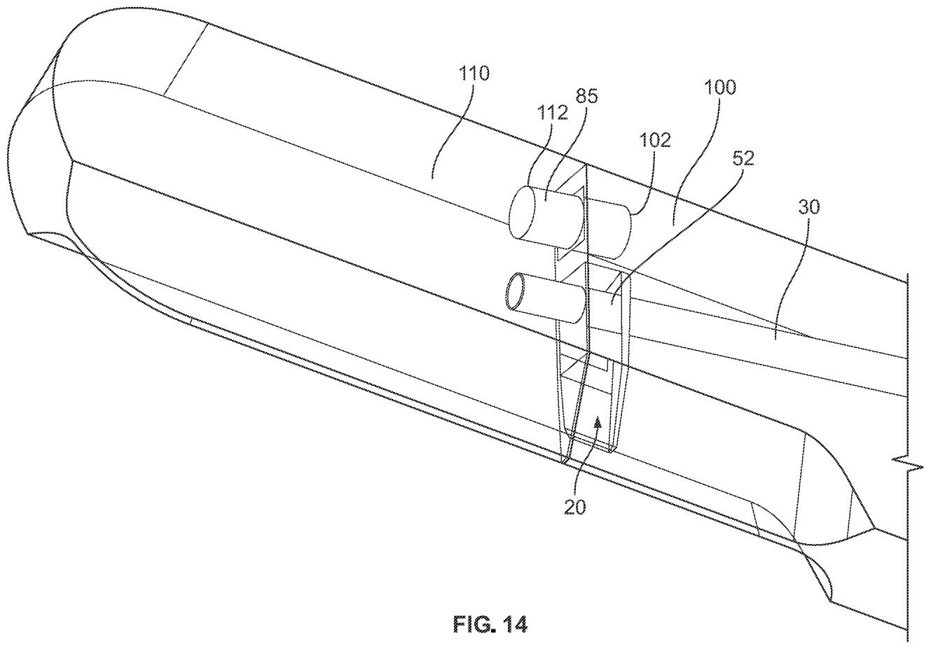

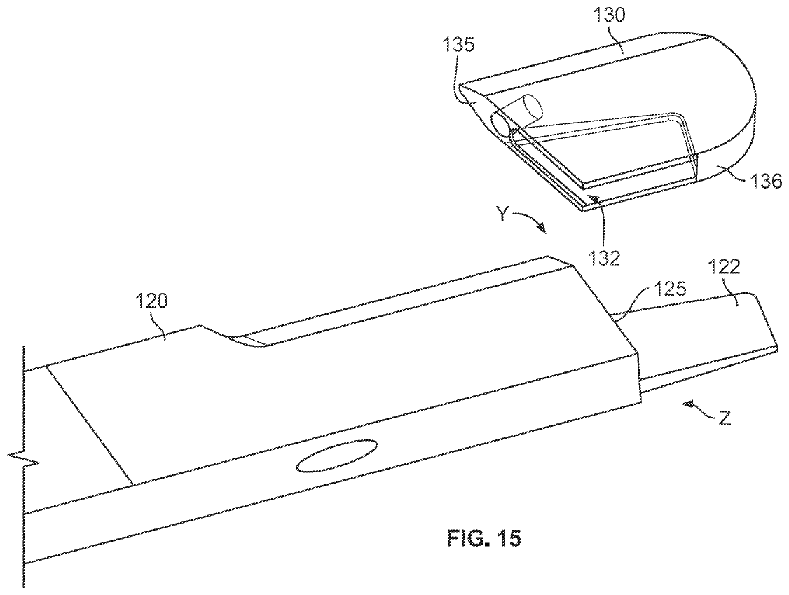

Referring now to FIG. 13, in one embodiment of the present disclosure, a main body 80 and a replaceable tip 90 each have mounting elements in the form of recesses 82, 92. A connector 85 (e.g., a pin) is adapted to be arranged in each of the corresponding pairs of the recesses 82, 92, such that the main body 80 and the tip 90 are engaged with one another via the connector. In some embodiments, the connectors 85 may be press fit, friction fit, or slip fit into either the recesses 82 and/or the recess 92. In other embodiments, one end of the connector 85 may be threaded into one of the recesses 82, 92. The connector or pin 85 may be a straight pin or may be tapered along its length (or in each direction from a center thereof). For example, a first radius R1 of a first end of the connector 85 may be greater than or less than a second radius R2 of a second end of the connector, with the radius of the connector tapering therebetween. As shown, the fastener 30 may be arranged generally between a pair of the connectors 85. Other aspects of the fastener 30 may remain unchanged from the previous embodiments. Referring to the embodiment of FIG. 14, only one connector 85 is arranged between a main body 100 and a tip 110. More specifically, the connector 85 is fitted within corresponding recesses 102, 112 in the above-described manner. As shown, this embodiment may include the boss 52, the recess 20 and the fastener 30 according to the previously described embodiments for selectively securing the tip 110 to the main body 100. In either embodiment, the connector or pin 85 is operative to resist bending and shear stresses between the main body and the end.

FIG. 15 illustrates an embodiment of an element having a tip 130 that may be slidably or frictionally fit over a free end of a main body 120 in a direction Y (i.e., along respective mating faces 125, 135 of the main body and the tip) and/or a direction Z. More specifically, the main body 120 defines a mounting member in the form of an integral protrusion 122 extending from the mating face 125. The tip 130 defines a corresponding mounting member in the form of an elongated recess 132 extending into the tip from the mating face 135 and toward a free end thereof. The recess 132 is open on the mating face 135 as well as on a trailing side 136 of the tip 130. The protrusion 122 and the recess 132 may be tapered. This embodiment is advantageous in that, by way of example, the tip 130 may be installed and/or removed from the main body 120 via relative movement in multiple directions (i.e., the directions Y and/or Z). Further, the weight of the tip 130 is reduced over the preceding embodiments, without requiring the formation of additional hollow interior space(s), simplifying manufacturing. However, in other embodiments, it should be appreciated that such a space may formed therein, as set forth with respect to the preceding embodiments of the present disclosure.

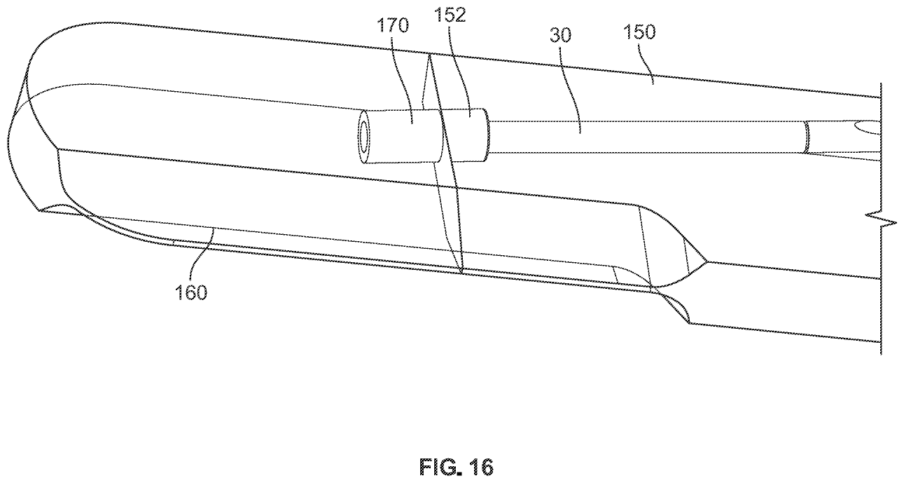

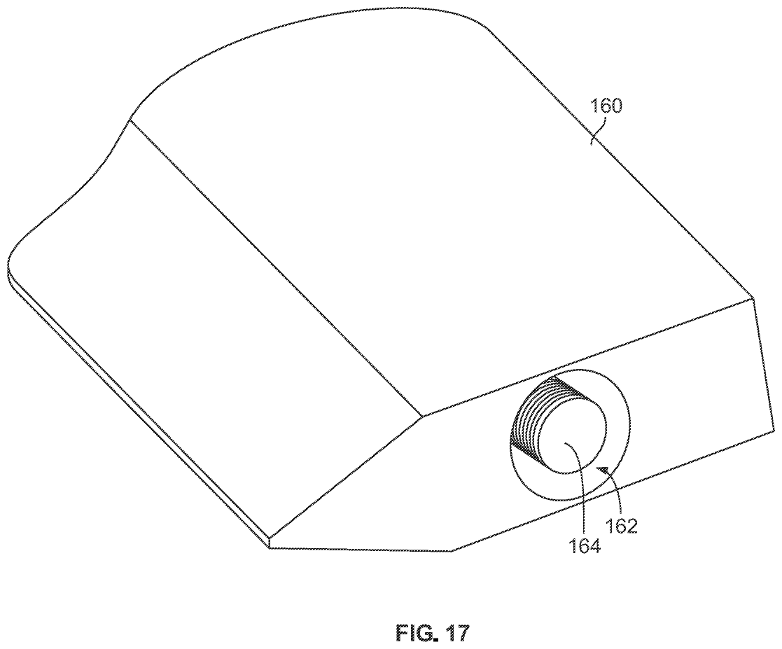

Referring now to FIGS. 16 and 17, in the exemplary embodiment of the element, a hollow sleeve or connector 170 is provided and adapted to connect a main body 150 to a replaceable tip 160. In one embodiment, the tip 160 includes a mounting member or element in the form of an annular recess 162 (see FIG. 17). An externally threaded protrusion 164 is formed within the recess 162, and is adapted to thready engage with an internal threading of the connector 170 for securing the connector to the tip 160. Of course, in other embodiments, the recess 162 may be generally hollow and internally threaded, with the connector 170 having an external thread for joining the connector to the tip 160.

The main body 150 defines a mounting member or element in the form of a recess 152 adapted to receive a portion of the connector 170 therein. As set forth above with respect to the embodiment of FIGS. 13 and 14, the connector 170 may be press fit, friction fit, or slip fit within the recess 152, by way of non-limiting example only. With the connector 170 threadably connected to the tip 160, and inserted into the recess 152 of the body 150, the fastener or fastening means 30 is adapted to, for example, threadably engage with the connector 170 (e.g., threadably engage with the internal threading of the connector 170), for drawing the tip 160 into securing contact with the body. It should be understood that in other embodiments of the present disclosure, the connector 170 may be bonded to and/or within the tip 160, or otherwise fixed thereto, without the use of complementary threading.

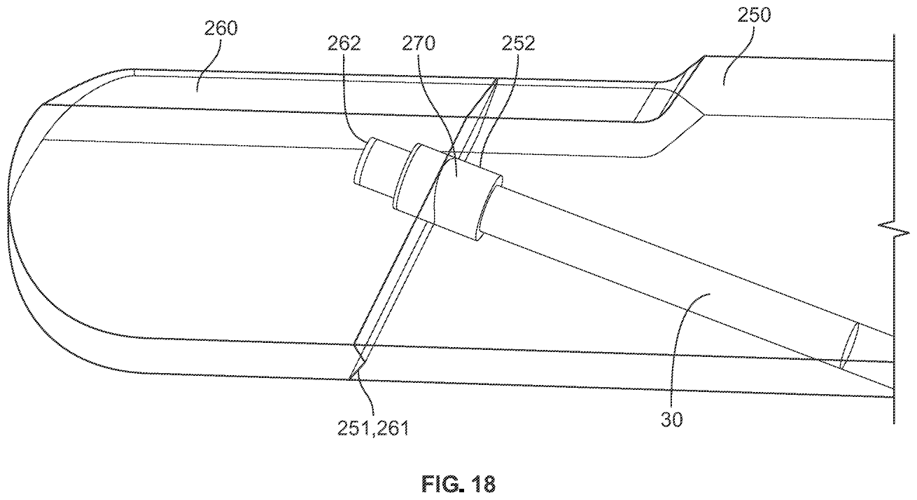

With reference to FIG. 18, in another embodiment, the element may include a main body 250, a tip 260, and a connector or hollow sleeve 270 arranged therebetween. As shown, each of the main body 250 and the tip 260 may define respective complementary angled abutment faces 251, 261, serving to locate the tip relative to the body. Unlike the above described embodiments, the connector 270 may define an unthreaded through-hole, and may function as a locating boss. The fastener 30 is adapted to pass freely through the connector 270, and engage with threads 262 formed in the tip 260. In some embodiments, the connector 270 may be brazed or otherwise fixed to the tip 260, with a locating hole formed within the main body 250 (e.g., a steel body) for receiving a portion of the connector 270.

While exemplary embodiments of the present disclosure are shown and described as having a recess defined in an end or main body of the element, and a boss formed on, or extending from, the removable tip or end, it should be understood that the reverse arrangement may be implemented without departing from the scope of the present invention. Specifically, a boss may be formed integrally with or affixed to (e.g., as an insert) the main body of the element, and a corresponding recess may be formed integrally with the replaceable end, or formed into an insert affixed to the end, without departing from the scope of the present disclosure. As these embodiments include substantially the same features already shown in the drawings, it is respectfully submitted that one of ordinary skill in the art would not require additional figures showing this reversal of parts in order to have a complete understanding of the disclosure invention.

Further, it should be understood that the overall shape of the elements shown in the figures is only exemplary in nature, and may be varied without departing from the scope of the present disclosure. For example, the distal or free end sides of each of the removable ends or tips may be rounded in nature (as shown), or may be squared-off or linearly angled. Likewise, the replaceable ends or tips may be generally flat or planar relative to the main body (as illustrated), or may be curved at least one of vertically upward or downward (i.e., toward a parallel relationship with a rotational axis of the element. In still other embodiments, the ends may extend obliquely upward and/or downward from the main body.

Elements according to embodiments of the present disclosure are generally adapted for use in material processing operations, including but not limited to, mixing, dispersing, cutting, milling, hammering, and/or agitating processes involving one or more materials (e.g., solid, liquid, and/or semiliquid materials). Likewise, while the elements (e.g., mixing elements) described herein may be generally referred to as impellers, it should be understood that this term includes blades, paddles, hammers, knives or other similar elements or tooling adapted to process (e.g., mix) one or more materials.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An impeller, comprising:
a body adapted to be operatively coupled to material processing machine, including:
a first mounting element defining at least one of a protrusion or a recess formed on a mounting end of the body; and
a through-hole extending through the body and adapted to receive a fastening means therein; and
a first tip removably attached to the body, including:
a second mounting element defining at least one of a protrusion or a recess formed on a mounting end of the first tip, the second mounting element adapted to connected to the first mounting element with the first tip attached to the body; and
a bore extending into the first tip, the bore and the through-hole being aligned with the first tip attached to the body.

2. The impeller of claim 1, wherein the second mounting element is complementary to the first mounting element such that first mounting element and the second mounting element are positively engaged with the first tip attached to the body.

3. The impeller of claim 2, further comprising a fastening means arranged within the through-hole and extending into the first tip, the fastening means adapted to selectively secure the first tip to the body.

4. The impeller of claim 3, wherein the fastening means and the bore are threadably engaged such that rotation of the fastening means engages the first and second mounting elements and fixes the first tip to the body.

5. The impeller of claim 1, wherein the body and the first tip define:
a first lateral side including a leading edge adapted to impact a material to be mixed; and
a second lateral side opposite the first lateral side, the through-hole having a first end opening on the second lateral side of the body.

6. The impeller of claim 5, wherein the first tip is attached to an end face of the body, the end face facing in a generally radially outward direction relative to a center of the body.

7. The impeller of claim 6, wherein a second end of the through-hole extends to the first mounting element and opens on the end face of the body.

8. The impeller of claim 7, wherein:
the first mounting element defines the recess and is formed into the end face of the body; and
the second end of the through hole opens into the recess.

9. The impeller of claim 8, wherein:
the second mounting element defines the protrusion; and
the protruding is sized to be received within the recess.

10. The impeller of claim 9, wherein the bore is formed into the protrusion.

11. The impeller of claim 10, wherein the protrusion forms an interference fit with the recess.

12. The impeller of claim 5, wherein the protrusion and the recess define corresponding tapered surfaces extending toward the first lateral side and into an area defining the leading edge of the element.

13. The impeller of claim 1, wherein the first tip further includes:
a tip body; and
an insert defining the second mounting element and fixed at least partially within the tip body.

14. The impeller of claim 13, wherein the body of the first tip is formed from a first material, and the insert of the first tip is formed from a second material, distinct from the first material.

15. The impeller of claim 13, wherein the body of the first tip includes at least an outer carbide surface.

16. The impeller of claim 1, further comprising a second tip removably attached to an end of the body opposite the first tip.

17. The impeller of claim 1, wherein:
a central axis of the through-hole is oriented obliquely relative to an axis of elongation of the body; and
the central axis is oriented at an angle of less than or equal to ninety degrees with respect to a plane defined by opposing mating surfaces of the body and first tip.

18. The impeller of claim 1, further comprising a connector arranged between and connected to the first mounting element and the second mounting element.

19. The impeller of claim 18, wherein:
the first mounting element and the second mounting element each define a recess; and
the connector includes a pin arranged in each of the recesses of the first and second mounting elements with the first tip attached to the body.

20. An impeller assembly, comprising:
a body defining a through-hole and adapted to be attached to a movable end of a material processing machine;
a tip removably attached to the body and defining a bore coaxially aligned with the through-hole with the tip attached to the body; and
a fastening means arranged in through-hole and engaging with the bore, the fastening means and through-hole adapted to selectively draw the tip into opposing contact with the body for securing the tip to the body.

21. The assembly of claim 20, wherein a central axis of the through-hole is oriented:
normal to a plane defined by opposed mating surfaces of the body and the tip; and
obliquely relative to a central axis of elongation of the body.

22. The assembly of claim 20, wherein tip defines a hollow interior cavity having a volume between 10% to 50% of an overall volume of the tip.

23. The assembly of claim 20, wherein the body and the tip define:
a first lateral side including a leading edge adapted to impact a material being processed; and
a second lateral side opposite the first lateral side, the through-hole having a first end opening on the second lateral side of the body.
